(19) United States
(12) Patent Application Publication
(10) Pub. No.: US 2022/0228681 A1
(43) Pub. Date: Jul. 21, 2022

(54) Finger-Tight Gas Chromatograph (GC) Column Connections

(71) Applicant: PerkinElmer Health Sciences, Inc, Waltham, MA (US)

(72) Inventors: Samuel Tolley, American Fork, UT (US); Christopher Bailey, American Fork, UT (US)

(21) Appl. No.: 17/573,067

(22) Filed: Jan. 11, 2022

Related U.S. Application Data
(60) Provisional application No. 63/138,631, filed on Jan. 18, 2021.

(51) Int. Cl. F16L 21/00; G01N 30/60

(52) U.S. Cl. CPC F16L 21/002; G01N 30/60

(57) ABSTRACT

A gas chromatograph (GC) column connection device includes a housing including first and second opposite ends, the housing including a housing bore extending therethrough between the first and second ends of the housing. The device includes: a piston in the housing bore; a ferrule at least partially in the housing bore at a second end of the piston; a biasing mechanism in the housing bore at a first end of the piston; and a retaining member in the housing bore between the first end of the housing and the biasing mechanism, with the retaining member spaced apart from the first end of the housing. The retaining member is configured to retain the biasing mechanism such that the biasing mechanism urges the piston axially toward the second end of the housing.

### RELATED APPLICATIONS

This application claims priority from U.S. Provisional Application No. 63/138,631, filed Jan. 18, 2021, the disclosure of which is hereby incorporated by reference in its entirety.

### BACKGROUND

A fitting is needed to connect a gas chromatograph (GC) column to each of the injector and detector of a GC. It is desirable for the fitting to be a finger-tight fitting (i.e., tighten without using tools).

### SUMMARY

According to some embodiments of the technology, a GC column connection device includes a housing including first and second opposite ends. The housing includes a housing bore extending therethrough between the first and second ends of the housing. A piston is in the housing bore and includes first and second opposite ends. A ferrule is at least partially in the housing bore at the second end of the piston (or is configured to be inserted to be at least partially in the housing bore at the second end of the piston). A biasing mechanism is in the housing bore at the first end of the piston. A retaining member is in the housing bore between the first end of the housing and the biasing mechanism with the retaining member spaced apart from the first end of the housing. The retaining member is configured to retain the biasing mechanism such that the biasing mechanism urges the piston axially toward the second end of the housing.

In some embodiments, the housing includes a first housing portion and a second housing portion, the piston is in the second housing portion, the first housing portion includes a flange extending radially outwardly away from the second housing portion, and the first housing portion includes a sidewall extending from the flange to the first end of the housing.

In some embodiments, the housing bore includes a first housing bore and a second housing bore in fluid communication with the first housing bore, the first housing bore is defined by the flange and the sidewall, the second housing bore is defined by the second housing portion, and the biasing mechanism and the retaining member are in the first housing bore.

In some embodiments, an annular groove is in an inner surface of the sidewall, and the retaining member is in the annular groove.

In some embodiments, the first housing bore includes tapered portion between the first end of the housing and the groove, the first housing bore includes a constant diameter portion between the flange and the groove, and the biasing mechanism is held in the constant diameter portion. The tapered portion of the first housing bore may decrease in diameter toward the groove such that, when the retaining member is inserted into the first housing bore, the retaining member is compressed by a ramped portion of the sidewall and then snaps into place in the groove thereby providing audible and/or tactile feedback.

In some embodiments, the biasing mechanism includes a plurality of conical spring washers. The sidewall may be a first sidewall, and the first housing portion may include a second sidewall extending from the flange to the first end of the housing, with the second sidewall spaced apart from and surrounding the first sidewall. In some embodiments, the first sidewall and/or the second sidewall is/are free of apertures, channels, or voids extending therethrough. The flange may include at least one aperture extending therethrough between the first and second sidewalls. The device may include a grip on the second sidewall configured for hand-tightening the device to a detector or injector of a GC system. An outer surface of the second sidewall may be knurled.

In some embodiments, the biasing mechanism is or consists of a single conical spring washer. The sidewall may be free of apertures, channels, or voids extending therethrough. The flange may include at least one aperture extending therethrough. The device may include a grip on the sidewall configured for hand-tightening the device to a detector or injector of a gas chromatograph. An outer surface of the sidewall may be knurled.

In some embodiments, the piston includes a primary body and a stop extending radially outwardly from the primary body with the stop at the flange. The piston may further include a projection extending from the stop toward the first end of the housing. The conical spring washer may surround the projection with the projection received in a bore of the conical spring washer.

In some embodiments, the first and second housing portions are monolithic.

In some embodiments, an outer surface of the second housing portion is threaded at the second end of the housing such that the device can threadingly engage a detector or injector of a GC.

In some embodiments, the device includes a GC column extending through respective bores of the retaining member, the biasing mechanism, the piston, and the ferrule.

In some embodiments, the ferrule includes a tapered outer surface, and compression of the tapered outer surface of the ferrule and a surface of a detector or injector of a GC compresses the ferrule against the GC column.

Some embodiments of the technology are directed to a GC column connection device including a housing including first and second opposite ends. The housing includes a housing bore extending therethrough between the first and second ends of the housing. The housing bore defines a longitudinal axis. A piston is in the housing bore and includes first and second opposite ends. A ferrule is in the housing bore at the second end of the piston. A biasing mechanism is in the housing bore at the first end of the piston. The biasing mechanism may include or consist of a conical spring washer. A retaining member is at the first end of the housing and configured to retain the biasing mechanism such that the biasing mechanism urges the piston axially toward the second end of the housing. A plurality of fasteners each extend parallel to the longitudinal axis through the retaining member and into the housing. The fasteners do not engage the conical spring washer.

Some embodiments of the technology are directed to a method for connecting a GC column to a detector or injector of a GC. The method includes providing a GC column connection device including: a housing including first and second opposite ends, the housing including a housing bore extending therethrough between the first and second ends of the housing; a piston in the housing bore, the piston comprising first and second opposite ends; a ferrule at least partially in the housing bore at the second end of the piston; a biasing mechanism in the housing bore at the first end of the piston; and a retaining member in the housing bore between the first end of the housing and the biasing mechanism, the retaining member spaced apart from the first end of the housing, the retaining member configured to retain the biasing mechanism such that the biasing mechanism urges the piston axially toward the second end of the housing. The method includes inserting a GC column through respective bores of the retaining member, the biasing mechanism, the piston, and the ferrule; threadingly engaging the second end of the housing with a detector or injector of a GC such that the GC column extends into an interior of the detector or injector; and rotating the housing relative to the detector or injector to form a fluidic seal between the ferrule and the piston and between the ferrule and a surface of the detector or injector.

In some embodiments, rotating the housing compresses the biasing mechanism between the retaining member and the piston, compresses the ferrule against the GC column, and compresses an outer surface of the ferrule against the surface of the detector or injector.

In some embodiments, the housing bore is at least partially defined by a sidewall at the first end of the housing, an annular groove is defined in the sidewall, and the sidewall includes a ramped portion between the first end of the housing and the annular groove. The method may further include assembling the GC column connection device including: receiving the piston in the housing bore; then receiving the biasing mechanism in the housing bore; then receiving the retaining member in the housing bore; then urging the retaining member in the housing bore toward the biasing mechanism; compressing the retaining member using the ramped portion of the sidewall in response to the urging; and then receiving the retaining member in the annular groove.

Further features, advantages and details of the present technology will be appreciated by those of ordinary skill in the art from a reading of the figures and the detailed description of the preferred embodiments that follow, such description being merely illustrative of the present technology.

### BRIEF DESCRIPTION OF THE DRAWINGS

FIG. 1 is a perspective view of a GC column connection device according to some embodiments.

FIG. 2 is a sectional view of the GC column connection device of FIG. 1.

FIG. 3 is a sectional view of the GC column connection device of FIG. 1 with a ferrule and a GC column not shown.

FIG. 4 is a perspective view of at least a portion of a biasing mechanism of the GC column connection device of FIG. 1.

FIG. 5 is a perspective view of a retaining member of the GC column connection device of FIG. 1.

FIG. 6 is a perspective view of a ferrule of the GC column connection device of FIG. 1.

FIG. 7 is a schematic sectional view illustrating the GC column connection device of FIG. 1 engaged with a detector or injector of a GC system.

FIG. 8 is a perspective view of a GC column connection device according to some embodiments.

FIG. 9 is a sectional view of the GC column connection device of FIG. 8.

FIG. 10 is a sectional view of the GC column connection device of FIG. 8 with a ferrule and a GC column not shown.

FIG. 11 is a perspective view of a biasing mechanism of the GC column connection device of FIG. 8.

FIG. 12 is a perspective view of a retaining member of the GC column connection device of FIG. 8.

FIG. 13 is a perspective view of a ferrule of the GC column connection device of FIG. 8.

FIG. 14 is a schematic sectional view illustrating the GC column connection device of FIG. 8 engaged with a detector or injector of a GC system.

FIG. 15 is a schematic sectional view illustrating a GC column connection device according to some embodiments engaged with a detector or injector of a GC system.

FIG. 16 is a perspective view of the GC column connection device of FIG. 8 with an alternative retaining member.

FIG. 17 is a perspective view of the retaining member of FIG. 16.

### DETAILED DESCRIPTION

Traditionally the connection of a GC column to each of the injector and detector of a GC requires one or more tools. This can make installing the column difficult and time consuming for a user. Additionally, the thermal cycling of the GC oven often deforms the connecting ferrule resulting in a leak. In accordance with embodiments of the technology, some or all of these problems can be addressed by providing a spring-force backing for the ferrule to maintain a seal after thermal cycling.

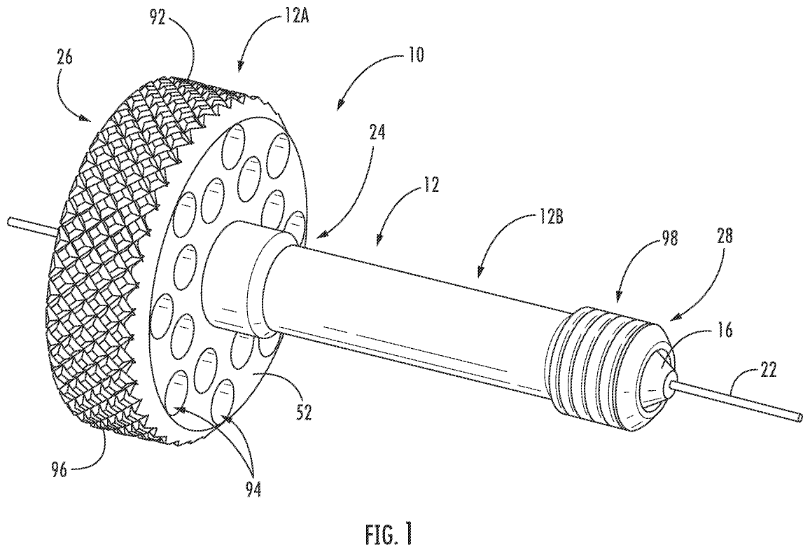

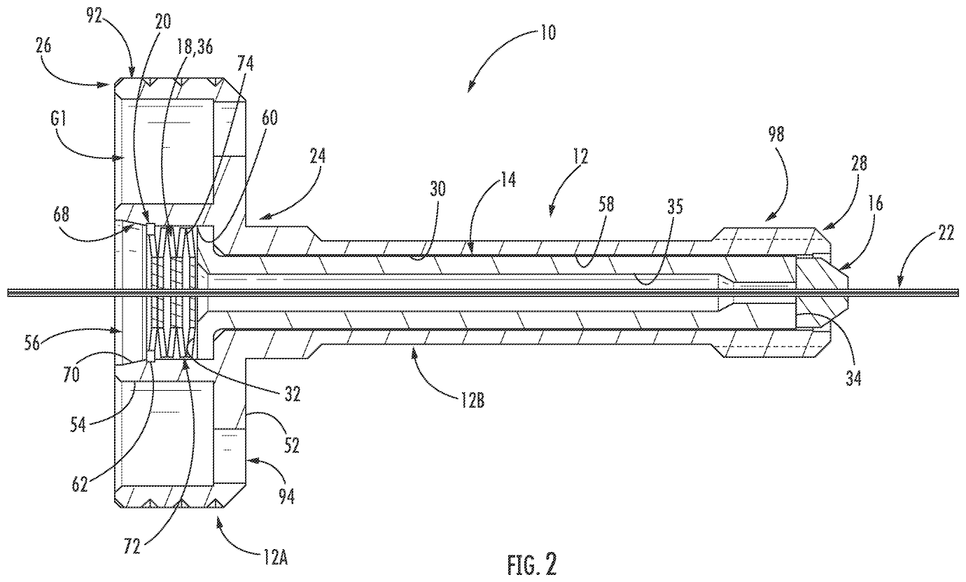

A GC column connection device 10 according to some embodiments is illustrated in FIGS. 1-3. The connection device 10 includes a housing 12, a piston 14, a ferrule 16, a biasing mechanism 18, and a retaining member 20. As described in more detail below, a GC column 22 may be received in the connection device 10.

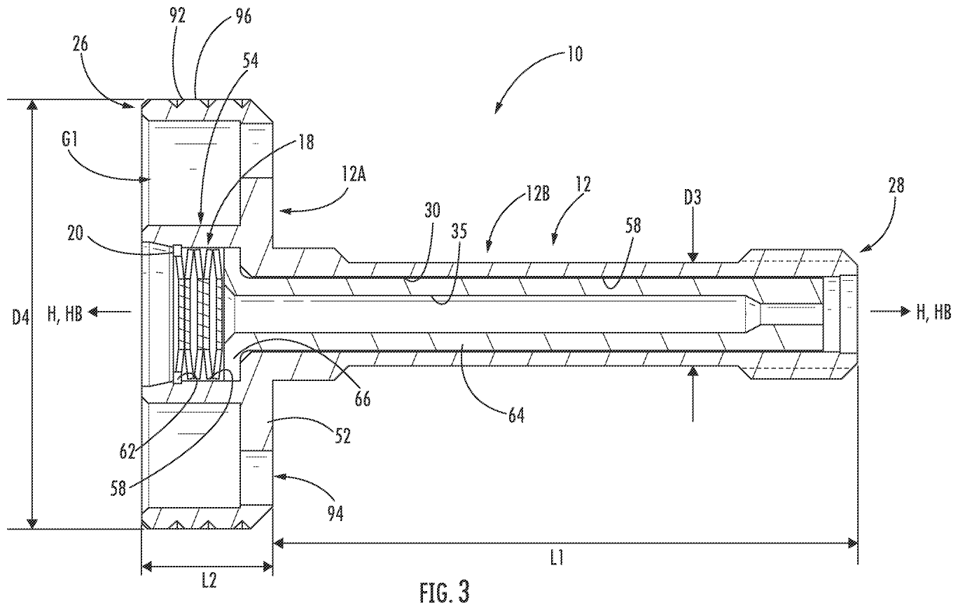

The connection device 10 is shown without the ferrule 16 and the GC column 22 in FIG. 3. Referring to FIGS. 1-3, the housing 12 includes a body 24. The body 24 may be formed of any suitable material. In some embodiments, the body 24 is formed of stainless steel. In some embodiments, the body 24 is monolithic.

The housing 12 defines a longitudinal axis H-H. The housing 12 includes first and second opposite ends 26, 28. The housing 12 includes a housing bore 30 extending between the first and second ends 26, 28. The housing bore 30 defines a longitudinal axis HB-HB. The housing longitudinal axis H-H and the housing bore longitudinal axis HB-HB may be coaxial.

The piston 14 is in the housing bore 30. The piston 14 includes first and second opposite ends 32, 34. The piston 14 includes a piston bore 35 extending between the first and second ends 32, 34. The piston 14 may be formed of any suitable material. In some embodiments, the piston 14 is formed of stainless steel. In some embodiments, the piston 14 is monolithic.

The biasing mechanism 18 is in the housing bore 30 at the first end 32 of the piston 14. The biasing mechanism 18 may include at least one conical spring washer 36. In some embodiments, the biasing mechanism 18 includes a plurality of conical spring washers 36 arranged in a stack (e.g., a coaxial stack).

The retaining member 20 is in the housing bore 30 between the first end 26 of the housing 12 and the biasing mechanism 18. The retaining member 20 is spaced apart from the first end 26 of the housing 12. The retaining member 20 is configured to retain the biasing mechanism 18 such that the biasing mechanism 18 urges the piston 14 axially (e.g., along the longitudinal axis H-H) toward the second end 28 of the housing 12.

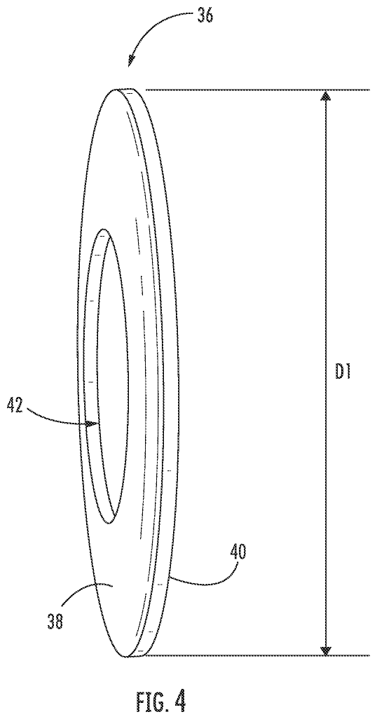

One of the conical spring washers 36 is illustrated in FIG. 4. The washer 36 includes first and second opposite sides 38, 40. The washer 36 includes a washer bore 42. The washer 36 may be formed of any suitable material. In some embodiments, the washer 36 is formed of an austenitic nickel-chromium-based superalloy such as Inconel. Such a material is capable of withstanding the thermal cycling of the GC oven without substantial change in shape or strength.

In some embodiments, the washer 36 has a diameter D1 of between 0.2 inches and 0.3 inches. In some embodiments, the washer 36 has a diameter D1 of about 0.236 inches.

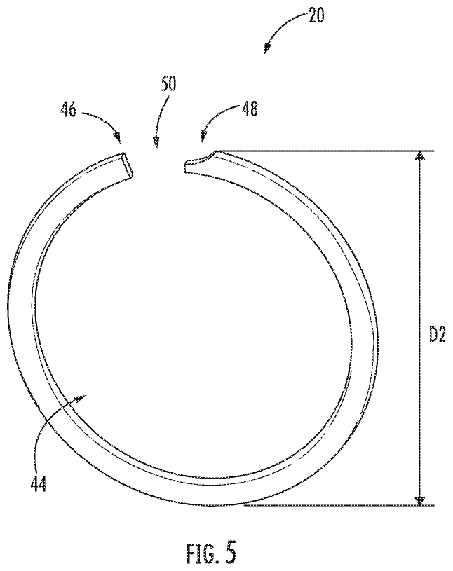

The retaining member 20 is illustrated in FIG. 5. The retaining member 20 includes a retaining member bore 44. The retaining member 20 may include first and second spaced apart ends 46, 48 defining a gap 50 therebetween. As described in more detail below, the gap 50 may allow the retaining member 20 to be compressed when being installed in the housing 12.

In some embodiments, the retaining member 20 has a diameter D2 of between 0.2 inches and 0.3 inches. In some embodiments, the retaining member 20 has a diameter D2 of about 0.248 inches. In some embodiments, D2 is larger than D1. For example, D2 may be 1-10% larger than D1. In some cases, D2 is about 5% larger than D1.

Referring again to FIGS. 1-3, the housing 12 includes a first housing portion 12A and a second housing portion 12B. The second housing portion 12B is elongated along the longitudinal axis H-H. The second housing portion 12B may have a length L1 of between 0.4 inches and 1.5 inches. In some embodiments, the second housing portion 12B has a length L1 of about 1.2 inches. The second housing portion 12B may have a diameter D3 of between 0.18 inches and 0.24 inches. In some embodiments, the second housing portion 12B has a diameter D3 of about 0.24 inches. In some embodiments, L1 is larger than D3. For example, L1 may be 200-600% larger than D3. In some cases, L1 is about 400% larger than D3.

The first housing portion 12A extends radially outwardly from the longitudinal axis H-H. The first housing portion 12A may have a length L2 of between 0.2 inches and 0.5 inches. In some embodiments, the first housing portion 12A has a length L2 of about 0.24 inches. In some embodiments, L1 is larger than L2. For example, L1 may be 200-600% larger than L2. In some cases, L1 is about 400% larger than L2. The first housing portion 12A may have a diameter D4 of between 0.3 inches and 1.0 inches. In some embodiments, the first housing portion 12A has a diameter D4 of about 0.78 inches. In some embodiments, D4 is larger than D3. For example, D4 may be 100-500% larger than D3. In some cases, D4 is about 225% larger than D3.

In some embodiments, D4 is larger than L2. For example, D4 may be 100-500% larger than L2. In some cases, D4 is about 225% larger than L2.

In some embodiments, the length of the housing (L1+L2) is larger than D1. For example, the length of the housing may be 300-700% larger than D1. In some cases, the length of the housing is about 510% larger than D1.

The first housing portion 12A includes a flange 52 extending outwardly away from the second housing portion 12B. The flange 52 may be annular and/or circular. The first housing portion 12A includes a sidewall 54 extending from the flange 52 to the first end 26 of the housing 12. The sidewall 54 may be an annular sidewall.

The housing bore 30 includes a first housing bore 56 and a second housing bore 58 in communication with one another. The first housing bore 56 is defined by the flange 52 and the sidewall 54. The second housing bore 58 is defined by the second housing portion 12B.

The biasing mechanism 18 and the retaining member 20 are in the first housing bore 56. The sidewall 54 includes an inner surface 60. An annular groove 62 is defined in the inner surface 60 of the sidewall 54. The retaining member 20 is held in the groove 62.

The piston 14 includes a primary body 64 and a stop 66 extending radially outwardly from the primary body 64. As described above, when the retaining member 20 is held in the groove 62, the retaining member 20 retains the biasing mechanism 18 such that the biasing mechanism 18 urges the piston 14 axially toward the second end 28 of the housing 12. The stop 66 may engage the flange 52 to restrain the piston 14 from further axial movement.

The inner surface 60 of the sidewall 54 may include a ramped or tapered portion 68 between the first end 26 of the housing 12 and the groove 62. The first housing bore 56 may include a corresponding tapered portion 70 that narrows from the first end 26 of the housing 12 toward the groove 62. The inner surface 60 of the sidewall 54 may include a constant diameter portion 72 between the flange 52 and the groove 60. The first housing bore 56 may include a corresponding constant diameter portion 74.

The ferrule 16 may be insertable at least partially in the housing bore 30 and, more specifically, at least partially in the second housing bore 58, such that the ferrule engages the second end 34 of the piston 14.

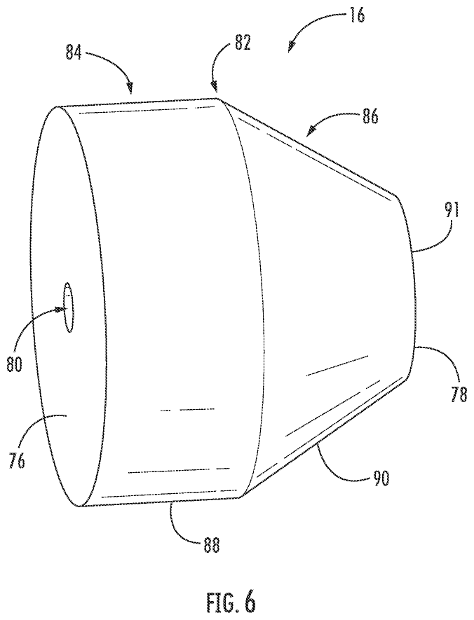

The ferrule 16 is illustrated in FIG. 6. The ferrule 16 includes first and second opposite ends 76, 78. The ferrule 16 includes a ferrule bore 80 extending between the first and second ends 76, 78. The ferrule includes a body 82. The body 82 may include a constant diameter portion 84 and a frustoconical or tapered portion 86. The constant diameter portion 84 includes an outer surface 88 and the tapered portion 86 includes an outer surface 90. The second end 78 of the ferrule 16 includes an outer surface 91. As described in more detail below, the outer surface 90 of the tapered portion 86 and/or the outer surface 91 of the second end 78 may engage a surface or surfaces of an injector or detector of a GC system to provide a seal for the GC column 22.

The ferrule 16 may be or include graphite. In some embodiments, the ferrule 16 includes graphite and a polymer (e.g., Vespel). In some embodiments, the ferrule 16 is elastically deformable.

Referring again to FIGS. 1-3, the connection device 10 may be assembled in the following manner. The piston 14 may be inserted in the housing bore 30. The spring washer(s) 36 may be inserted into the housing bore 30 at the first end 32 of the piston 14. The retaining member 20 may then be inserted into the groove 62. In some embodiments, as the retaining member 20 is inserted into the housing bore 30, the retaining member 20 is gradually compressed by the ramped portion 68 of the sidewall 54 until it snaps into the groove 62. This helps ensure that the retaining member 20 is firmly held in the groove 62 to retain the spring washer(s) 36. The ferrule 16 is then inserted at least partially into the housing bore 30 and the GC column 22 is then inserted through the ferrule bore 80, the piston bore 35, the washer bore(s) 42, and the retaining member bore 44.

Still referring to FIGS. 1-3, in some embodiments, the sidewall 54 is a first sidewall and the first housing portion 12A includes a second sidewall 92 extending from the flange 52 to the first end 26 of the housing 12. The second sidewall 92 may be spaced apart from and surround the first sidewall 54. The second sidewall 92 may be an annular sidewall.

An annular gap G1 is defined between the first sidewall 54 and the second sidewall 92. The gap G1 may help with heat management. At least one aperture 94 may be in the flange 52 between the first sidewall 54 and the second sidewall 92. The at least one aperture 94 may also help with heat management. As illustrated, there may be a plurality of the apertures 94.

As noted above, the second sidewall 92 is spaced apart from the first sidewall 54. The second sidewall 92 therefore has a greater diameter than the first sidewall 54. This allows a user to apply more torque when installing the device. In some embodiments, a grip or handle 96 is on the second sidewall 92. The grip 96 may be knurled to further assist a user to install the device.

In some embodiments, the first sidewall 54 and/or the second sidewall 92 are free of apertures, channels, or voids extending therethrough. This is in contrast to some known connection devices wherein a cap or other member is used to retain the biasing mechanism or spring and fasteners are advanced through apertures in the body to retain the cap.

The housing 12 may include a threaded portion 98 at the second end 28 of the housing 12. The threaded portion 98 may threadingly engage a detector or injector of a GC system.

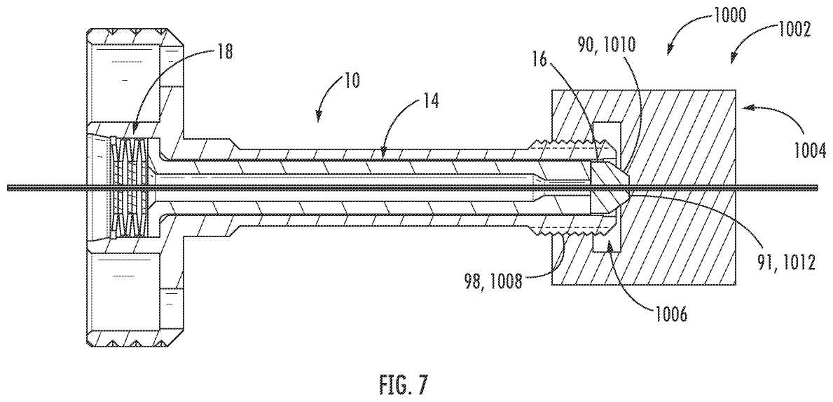

FIG. 7 illustrates the device 10 installed in a detector or injector 1002 of a GC system 1000. The detector or injector 1002 includes a body 1004. The body 1004 includes a bore 1006 and a threaded portion 1008. In the illustrated embodiment, a user has hand-tightened the device 10 such that the threaded portion 98 of the device is threadingly engaged with the threaded portion 1008 of the detector or injector body 1004. The detector or injector body 1004 may include a tapered inner surface 1010 and an inner end surface 1012.

Rotation of the device 10 to the position shown in FIG. 7 compresses the biasing mechanism 18, which in turn axially translates the piston 14 against the ferrule 16. Referring to FIGS. 6 and 7, this urges the outer surface 90 of the tapered portion 86 of the ferrule 16 against the tapered inner surface 1010 of the detector or injector body 1004. The outer surface 91 of the second end 78 of the ferrule 16 may also be urged against the inner end surface 1012 of the of the detector or injector body 1004. The resulting compression causes the ferrule 16 to radially bear down on the GC column 22 to contribute to a fluidic seal.

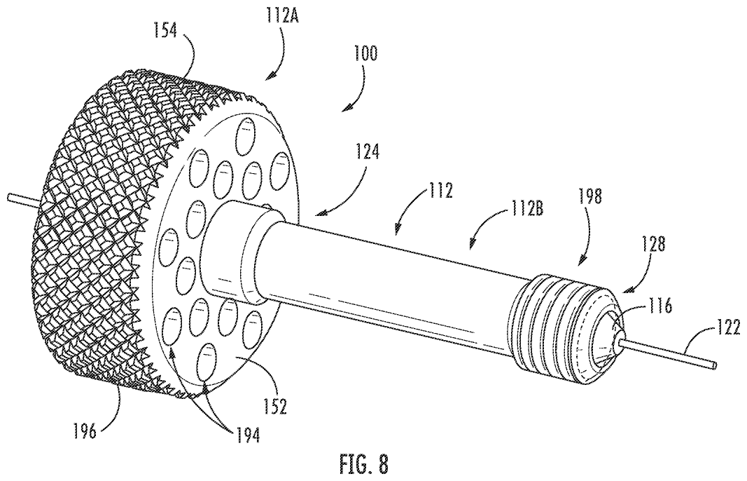

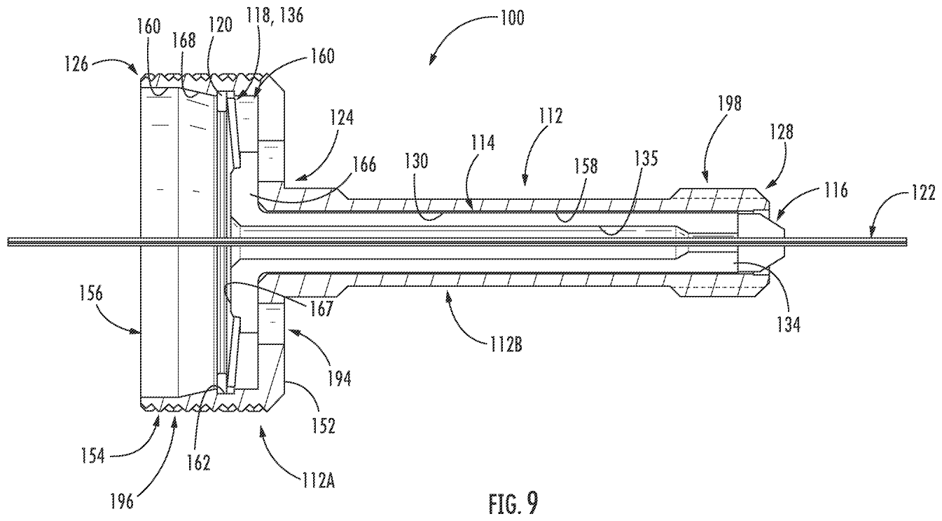

A GC column connection device 100 according to some embodiments is illustrated in FIGS. 8-10. The connection device 10 includes a housing 112, a piston 114, a ferrule 116, a biasing mechanism 118, and a retaining member 120. As described in more detail below, a GC column 122 may be received in the connection device 100.

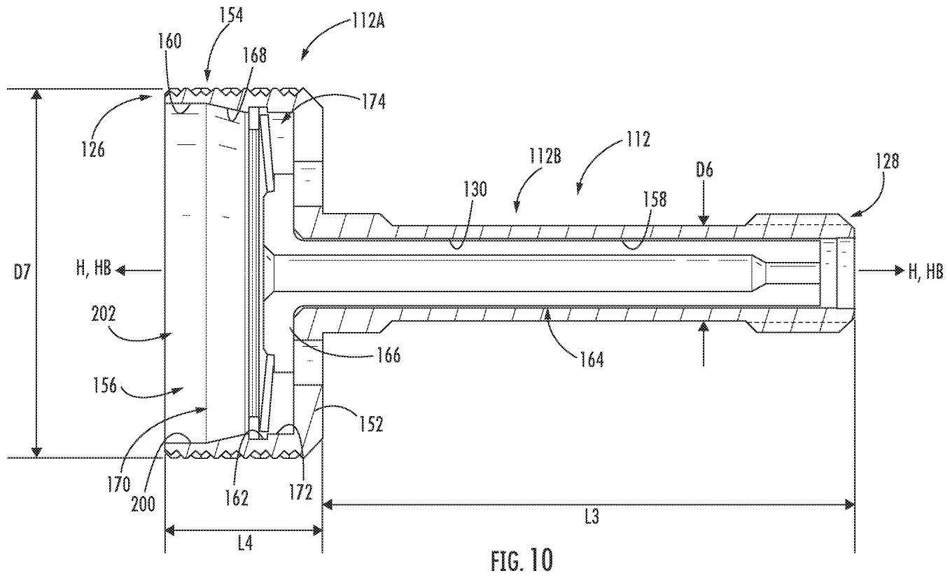

The connection device 100 is shown without the ferrule 116 and the GC column 122 in FIG. 10. Referring to FIGS. 8-10, the housing 112 includes a body 124. The body 124 may be formed of any suitable material. In some embodiments, the body 124 is formed of stainless steel. In some embodiments, the body 124 is monolithic.

The housing 112 defines a longitudinal axis H-H. The housing 112 includes first and second opposite ends 126, 128. The housing 112 includes a housing bore 130 extending between the first and second ends 126, 128. The housing bore 130 defines a longitudinal axis HB-HB. The housing longitudinal axis H-H and the housing bore longitudinal axis HB-HB may be coaxial.

The piston 114 is in the housing bore 130. The piston 114 includes first and second opposite ends 132, 134. The piston 114 includes a piston bore 135 extending between the first and second ends 132, 134. The piston 114 may be formed of any suitable material. In some embodiments, the piston 114 is formed of stainless steel. In some embodiments, the piston 114 is monolithic.

The biasing mechanism 118 is in the housing bore 30 at the first end 32 of the piston 14. In some embodiments, the biasing mechanism 118 is a single conical spring washer 136.

The retaining member 120 is in the housing bore 130 between the first end 126 of the housing 112 and the biasing mechanism 118. The retaining member 120 is spaced apart from the first end 126 of the housing 112. The retaining member 120 is configured to retain the biasing mechanism 118 such that the biasing mechanism 118 urges the piston 114 axially (e.g., along the longitudinal axis H-H) toward the second end 128 of the housing 112.

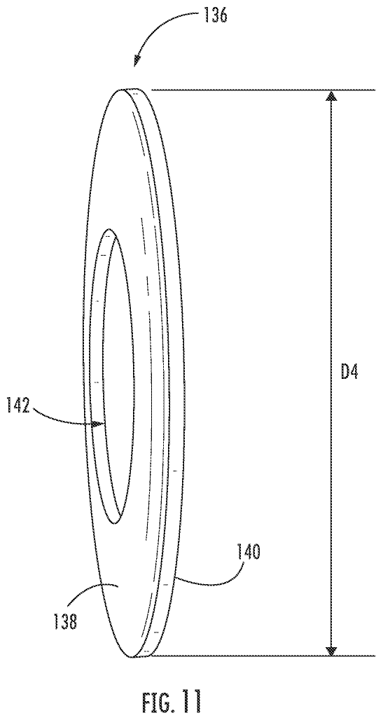

The conical spring washer 136 is illustrated in FIG. 11. The washer 136 includes first and second opposite sides 138, 140. The washer 136 includes a washer bore 142. The washer 136 may be formed of any suitable material. In some embodiments, the washer 136 is formed of an austenitic nickel-chromium-based superalloy such as Inconel available from American Ring. Such a material is capable of withstanding the thermal cycling of the GC oven without substantial change in shape or strength.

In some embodiments, the washer 136 has a diameter D4 of between 0.6 inches and 0.7 inches. In some embodiments, the washer 136 has a diameter D4 of about 0.630 inches.

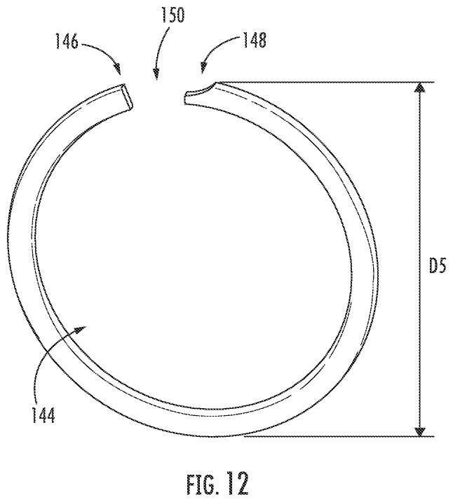

The retaining member 120 is illustrated in FIG. 12. The retaining member 120 includes a retaining member bore 144. The retaining member 120 may include first and second spaced apart ends 146, 148 defining a gap 150 therebetween. As described in more detail below, the gap 150 may allow the retaining member 120 to be compressed when being installed in the housing 112.

In some embodiments, the retaining member 120 has a diameter D5 of between 0.6 inches and 0.7 inches. In some embodiments, the retaining member 120 has a diameter D5 of about 0.67 inches. In some embodiments, D5 is larger than D4. For example, D5 may be 1-10% larger than D4. In some cases, D5 is about 6% larger than D4.

Referring again to FIGS. 8-10, the housing 112 includes a first housing portion 112A and a second housing portion 112B. The second housing portion 112B is elongated along the longitudinal axis H-H. The second housing portion 112B may have a length L3 of between 0.4 inches and 1.5 inches. In some embodiments, the second housing portion 112B has a length L3 of about 1.2 inches. The second housing portion 112B may have a diameter D6 of between 0.18 inches and 0.24 inches. In some embodiments, the second housing portion 112B has a diameter D6 of about 0.24 inches. In some embodiments, L3 is larger than D6. For example, L3 may be 200-600% larger than D6. In some cases, L3 is about 400% larger than D6.

The first housing portion 112A extends radially outwardly from the longitudinal axis H-H. The first housing portion 112A may have a length L4 of between 0.2 inches and 0.5 inches. In some embodiments, the first housing portion 112A has a length L4 of about 0.24 inches. In some embodiments, L3 is larger than L4. For example, L3 may be 200-600% larger than L4. In some cases, L3 is about 400% larger than L4. The first housing portion 112A may have a diameter D7 of between 0.3 inches and 1.0 inches. In some embodiments, the first housing portion 112A has a diameter D7 of about 0.78 inches. In some embodiments, D7 is larger than D6. For example, D7 may be 100-500% larger than D6. In some cases, D7 is about 225% larger than D6.

In some embodiments, D7 is larger than L4. For example, D7 may be 100-500% larger than L4. In some cases, D7 is about 225% larger than L4.

In some embodiments, the length of the housing (L3+L4) is larger than D4. For example, the length of the housing may be 100-500% larger than D4. In some cases, the length of the housing is about 130% larger than D4.

The first housing portion 112A includes a flange 152 extending outwardly away from the second housing portion 112B. The flange 152 may be annular and/or circular. The first housing portion 112A includes a sidewall 154 extending from the flange 152 to the first end 126 of the housing 112. The sidewall 154 may be an annular sidewall.

The housing bore 130 includes a first housing bore 156 and a second housing bore 158 in communication with one another. The first housing bore 156 is defined by the flange 152 and the sidewall 154. The second housing bore 158 is defined by the second housing portion 112B.

The biasing mechanism 118 and the retaining member 120 are in the first housing bore 156. The sidewall 154 includes an inner surface 160. An annular groove 162 is defined in the inner surface 160 of the sidewall 154. The retaining member 120 is held in the groove 162.

The piston 114 includes a primary body 164 and a stop 166 extending radially outwardly from the primary body 164. As described above, when the retaining member 120 is held in the groove 162, the retaining member 120 retains the biasing mechanism 118 such that the biasing mechanism 118 urges the piston 114 axially toward the second end 128 of the housing 112. The stop 166 may engage the flange 152 to restrain the piston 114 from further axial movement. The piston 114 may include a projection 167 extending from the stop 166 toward the first end 126 of the housing. The washer 136 may surround the projection 167 and the projection 167 may be received in the bore 142 of the washer 136 (FIG. 11),

The inner surface 160 of the sidewall 154 may include a ramped or tapered portion 168 between the first end 126 of the housing 112 and the groove 162. The first housing bore 156 may include a corresponding tapered portion 170 that narrows from the first end 126 of the housing 112 toward the groove 162. The inner surface 160 of the sidewall 154 may include a constant diameter portion 172 between the flange 152 and the groove 162. The first housing bore 156 may include a corresponding constant diameter portion 174.

In some embodiments, the inner surface 160 of the sidewall 154 may include a first constant diameter portion 200 between the first end 126 of the housing 112 and the ramped or tapered portion 168 of the sidewall 154. The first housing bore 156 may include a corresponding first constant diameter portion 202. The ramped or tapered portion 168 may be between the first constant diameter portion 202 and the groove 162. The first housing bore 156 may include the corresponding tapered portion 170 that narrows from the first constant diameter portion 200 toward the groove 162. The second constant diameter portion 172 may be between the groove 162 and the flange 152. The first housing bore 156 may include the corresponding second constant diameter portion 174.

The ferrule 116 may be insertable at least partially in the housing bore 130 and, more specifically, at least partially in the second housing bore 158, such that the ferrule engages the second end 134 of the piston 114.

The ferrule 116 is illustrated in FIG. 6. The ferrule 116 includes first and second opposite ends 176, 178. The ferrule 116 includes a ferrule bore 180 extending between the first and second ends 176, 178. The ferrule includes a body 182. The body 182 may include a constant diameter portion 184 and a frustoconical or tapered portion 186. The constant diameter portion 184 includes an outer surface 188 and the tapered portion 186 includes an outer surface 190. The second end 178 of the ferrule 116 includes an outer surface 191. As described in more detail below, the outer surface 190 of the tapered portion 186 and/or the outer surface 191 of the second end 178 may engage a surface or surfaces of an injector or detector of a GC system to provide a seal for the GC column 122.

The ferrule 116 may be or include graphite. In some embodiments, the ferrule 116 includes graphite and a polymer (e.g., Vespel). The ferrule 116 may be elastically deformable.

Referring again to FIGS. 8-10, the connection device 100 may be assembled in the following manner. The piston 114 may be inserted in the housing bore 130. The spring washer 136 may be inserted into the housing bore 130 at the first end 132 of the piston 114. The retaining member 120 may then be inserted into the groove 162. In some embodiments, as the retaining member 120 is inserted into the housing bore 130, the retaining member 120 is gradually compressed by the ramped portion 168 of the sidewall 154 until it snaps into the groove 162. This helps ensure that the retaining member 120 is firmly held in the groove 162 to retain the spring washer 136. The ferrule 116 is then inserted at least partially into the housing bore 130 and the GC column 122 is then inserted through the ferrule bore 180, the piston bore 135, the washer bore 142, and the retaining member bore 144.

Still referring to FIGS. 8-10, in some embodiments, at least one aperture 194 may be in the flange 152. The at least one aperture 194 may help with heat management. As illustrated, there may be a plurality of the apertures 194.

The relatively large diameter D3 of the first housing portion 112A allows a user to apply more torque when installing the device. In some embodiments, a grip or handle 196 is on the sidewall 154. The grip 196 may be knurled to further assist a user install the device.

In some embodiments, the sidewall 54 is free of apertures, channels, or voids extending therethrough. This is in contrast to some known connection devices wherein a cap or other member is used to retain the biasing mechanism or spring and fasteners are advanced through apertures in the body to retain the cap.

The housing 112 may include a threaded portion 198 at the second end 128 of the housing 112. The threaded portion 198 may threadingly engage a detector or injector of a GC system.

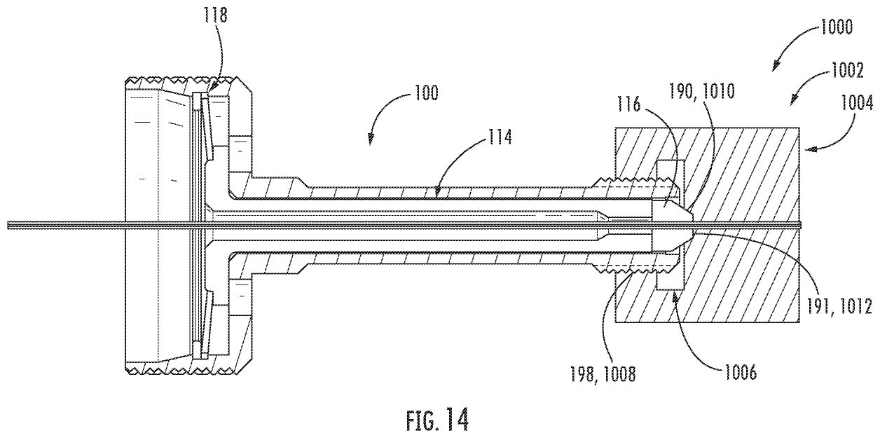

FIG. 14 illustrates the device 100 installed in a detector or injector 1002 of a GC system 1000. The detector or injector 1002 includes a body 1004. The body 1004 includes a bore 1006 and a threaded portion 1008. In the illustrated embodiment, a user has hand-tightened the device 100 such that the threaded portion 198 of the device is threadingly engaged with the threaded portion 1008 of the detector or injector body 1004. The detector or injector body 1004 may include a tapered inner surface 1010 and an inner end surface 1012.

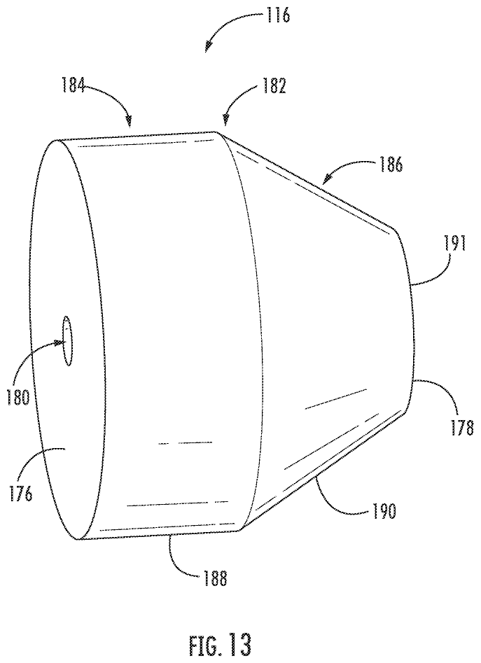

Rotation of the device 100 to the position shown in FIG. 14 compresses the biasing mechanism 118, which in turn axially translates the piston 114 against the ferrule 116. Referring to FIGS. 13 and 14, this urges the outer surface 190 of the tapered portion 186 of the ferrule 116 against the tapered inner surface 1010 of the detector or injector body 1004. The outer surface 191 of the second end 718 of the ferrule 116 may also be urged against the inner end surface 1012 of the of the detector or injector body 1004. The resulting compression causes the ferrule 116 to radially bear down on the GC column 122 to contribute to a fluidic seal.

Traditionally the connection of a GC column to a detector or injector of a GC system requires one or more tools. It is desirable to have a tool-less finger-tight connector that has spring force backing the ferrule to maintain a seal after thermal cycling.

Some known finger-tight connection devices use additional components such as a cap to retain the spring in place. The cap is rotated on a housing to compress the spring. There are pins that are received through the housing and the cap to retain the cap in place.

The finger-tight connection devices 10, 100 are easier and more economical to assemble than known finger-tight connection devices. For example, the retaining member 20, 120 is positioned to compress the spring and requires no manipulation by the installer. The finger-tight connection devices 10, 100 are also easier to install than known finger-tight connection devices. For example, the installer rotates the entire device to obtain the fluidic seal and does not have to manipulate additional components such as caps and pins.

The finger-tight connection device 100 may provide further advantages. For example, the device 100 uses a single washer 136 with a larger diameter. The single, larger washer has a longer traveling distance and further eases assembly.

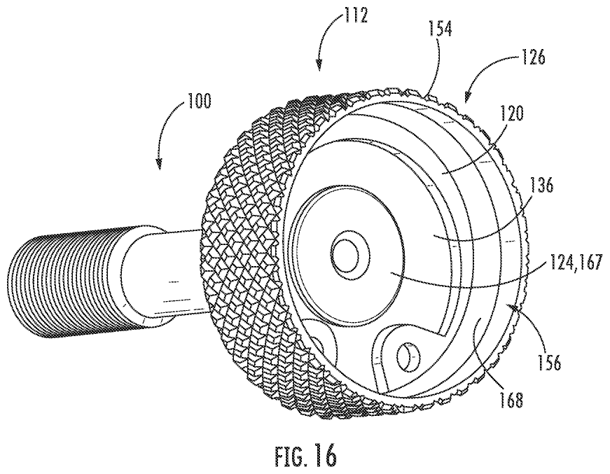

The connection device 100 according to another embodiment is illustrated in FIG. 16. The connection device 100 is as described above but includes a stronger, wider retaining member 120 and a deeper groove 162 (FIG. 10). This may help prevent force in the washer 136 from pushing the retaining member 120 out of the groove 162.

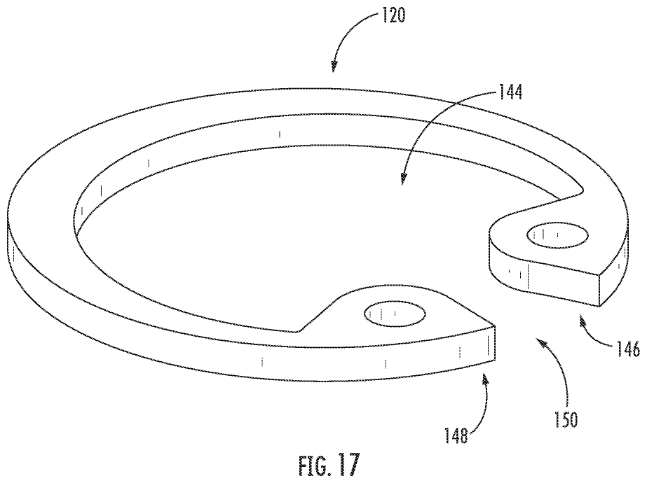

The retaining member 120 is shown in greater detail in FIG. 17. The retaining member 120 includes a retaining member bore 144. The retaining member 120 may include first and second spaced apart ends 146, 148 defining a gap 150 therebetween. The gap 150 may help the retaining member 120 to be compressed when being installed in the housing 112.

The connection device 100 is shown in its assembled state in FIG. 16. In some embodiments, to assemble the connection device 100, the piston 124 is received in the housing 112 and then the washer 136 is received in the housing (e.g., surrounding the projection 167 of the piston 124). The retaining member 120 is then received in the housing 112. A tool (e.g., a cylindrical ram) is then pressed into the opening at the first end 126 of the housing 112. The tool urges the retaining member 120 through the first housing bore 156 of the housing 112 and the ramp 168 on the sidewall 154 of the housing 112 compresses the retaining member 120 until it is received in the groove 162 (FIG. 10). There may be audible and/or tactile feedback (e.g., a click) when the retaining member 120 until it is received in the groove 162 and the assembly process is completed. This design eases assembly and reduces assembly cost and time compared to known connection devices.

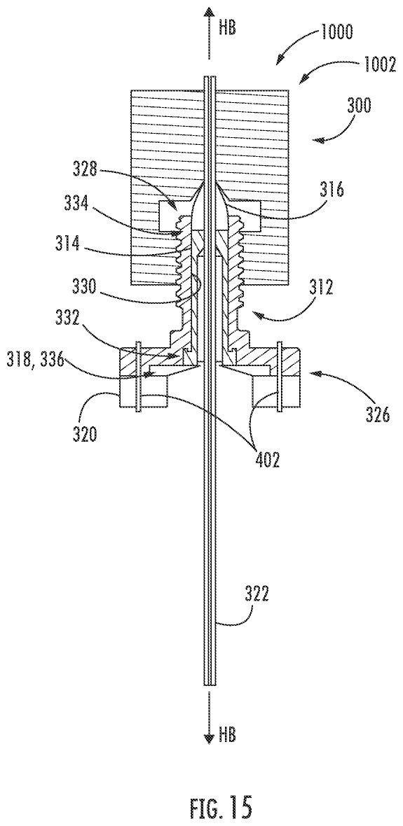

A GC column connection device 300 according to some embodiments is illustrated in FIG. 15. The device 300 includes a housing 312 including first and second opposite ends 326, 328. The housing 312 includes a housing bore 330 extending between the first and second opposite ends 326, 328 of the housing 312. The housing bore 330 defines a longitudinal axis HB-HB. A piston 314 is in the housing bore 330. The piston 314 includes first and second opposite ends 332, 334. A ferrule 316 is at least partially in the housing bore 330 at the second end 334 of the piston 314. A biasing mechanism 318 is in the housing bore 330 at the first end 332 of the piston 314. In some embodiments, the biasing mechanism 318 includes at least one conical spring washer. In some embodiments, the biasing mechanism consists of a single conical spring washer.

A retaining member 320 is at the first end 326 of the housing 312 and is configured to retain the biasing mechanism such that the biasing mechanism 318 urges the piston 314 axially toward the second end 328 of the housing 312. A plurality of fasteners 402 such as screws or rivets each extend parallel to the longitudinal axis HB-HB through the retaining member 320 and into the housing 312. The fasteners 402 do not engage the biasing mechanism 318.

The device 300 may be installed in the detector or injector 1002 of a GC system 1000 in a similar manner as described above with regard to the devices 10, 100.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items. When the term “about” or “substantially equal to” is used in the specification the intended meaning is that the value is plus or minus 5% of the specified value.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present technology are explained in detail in the specification set forth herein.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing is illustrative of the present technology and is not to be construed as limiting thereof. Although a few example embodiments of this technology have been described, those skilled in the art will readily appreciate that many modifications are possible in the example embodiments without materially departing from the teachings and advantages of this technology. Accordingly, all such modifications are intended to be included within the scope of this technology as defined in the claims. The technology is defined by the following claims, with equivalents of the claims to be included therein.

What is claimed is:

1. A gas chromatograph (GC) column connection device comprising:
a housing comprising first and second opposite ends, the housing comprising a housing bore extending therethrough between the first and second ends of the housing;
a piston in the housing bore, the piston comprising first and second opposite ends;
a ferrule at least partially in the housing bore at the second end of the piston;
a biasing mechanism in the housing bore at the first end of the piston; and
a retaining member in the housing bore between the first end of the housing and the biasing mechanism, the retaining member spaced apart from the first end of the housing, the retaining member configured to retain the biasing mechanism such that the biasing mechanism urges the piston axially toward the second end of the housing.

2. The device of claim 1 wherein:
the housing comprises a first housing portion and a second housing portion,
the piston is in the second housing portion,
the first housing portion comprises a flange extending radially outwardly away from the second housing portion, and
the first housing portion comprises a sidewall extending from the flange to the first end of the housing.

3. The device of claim 2 wherein:
the housing bore comprises a first housing bore and a second housing bore in fluid communication with the first housing bore,
the first housing bore is defined by the flange and the sidewall,
the second housing bore is defined by the second housing portion, and
the biasing mechanism and the retaining member are in the first housing bore.

4. The device of claim 3 further comprising:
an annular groove in an inner surface of the sidewall, wherein the retaining member is in the annular groove.

5. The device of claim 4 wherein:
the first housing bore comprises tapered portion between the first end of the housing and the groove,
the first housing bore comprises a constant diameter portion between the flange and the groove, and
the biasing mechanism is held in the constant diameter portion.

6. The device of claim 5 wherein the tapered portion of the first housing bore decreases in diameter toward the groove such that, when the retaining member is inserted into the first housing bore, the retaining member is compressed by a ramped portion of the sidewall and then snaps into place in the groove thereby providing audible and/or tactile feedback.

7. The device of claim 3 wherein the biasing mechanism is a single conical spring washer.

8. The device of claim 7 wherein the sidewall is free of apertures, channels, or voids extending therethrough.

9. The device of claim 7 wherein the flange comprises at least one aperture extending therethrough.

10. The device of claim 7 further comprising a grip on the sidewall configured for hand-tightening the device to a detector or injector of a gas chromatograph, wherein an outer surface of the sidewall is optionally knurled.

11. The device of claim 7 wherein the piston comprises a primary body and a stop extending radially outwardly from the primary body with the stop at the flange, the piston further comprising a projection extending from the stop toward the first end of the housing, and wherein the conical spring washer surrounds the projection with the projection received in a bore of the conical spring washer.

12. The device of claim 3 wherein the biasing mechanism comprises a plurality of conical spring washers.

13. The device of claim 12 wherein:
the sidewall is a first sidewall,
the first housing portion comprises a second sidewall extending from the flange to the first end of the housing, the second sidewall spaced apart from and surrounding the first sidewall.

14. The device of claim 13 wherein the first sidewall and/or the second sidewall is/are free of apertures, channels, or voids extending therethrough.

15. The device of claim 2 wherein an outer surface of the second housing portion is threaded at the second end of the housing such that the device can threadingly engage a detector or injector of a GC.

16. The device of claim 1 further comprising a GC column extending through respective bores of the retaining member, the biasing mechanism, the piston, and the ferrule.

17. The device of claim 16 wherein:
the ferrule comprises a tapered outer surface, and
compression of the tapered outer surface of the ferrule and a surface of a detector or injector of a GC compresses the ferrule against the GC column.

18. A method for connecting a gas chromatograph (GC) column to a detector or injector of a GC, the method comprising:
providing a GC column connection device comprising:
a housing comprising first and second opposite ends, the housing comprising a housing bore extending therethrough between the first and second ends of the housing;
a piston in the housing bore, the piston comprising first and second opposite ends;
a ferrule at least partially in the housing bore at the second end of the piston;
a biasing mechanism in the housing bore at the first end of the piston; and
a retaining member in the housing bore between the first end of the housing and the biasing mechanism, the retaining member spaced apart from the first end of the housing, the retaining member configured to retain the biasing mechanism such that the biasing mechanism urges the piston axially toward the second end of the housing;
inserting a GC column through respective bores of the retaining member, the biasing mechanism, the piston, and the ferrule;
threadingly engaging the second end of the housing with a detector or injector of a GC such that the GC column extends into an interior of the detector or injector; and
rotating the housing relative to the detector or injector to form a fluidic seal between the ferrule and the piston and between the ferrule and a surface of the detector or injector.

19. The method of claim 18 wherein:
the housing bore is at least partially defined by a sidewall at the first end of the housing,
an annular groove is defined in the sidewall,
the sidewall comprises a ramped portion between the first end of the housing and the annular groove,
the method further comprises assembling the GC column connection device comprising:
receiving the piston in the housing bore; then
receiving the biasing mechanism in the housing bore; then
receiving the retaining member in the housing bore; then
urging the retaining member in the housing bore toward the biasing mechanism;
compressing the retaining member using the ramped portion of the sidewall in response to the urging; and then
receiving the retaining member in the annular groove.

20. A gas chromatograph (GC) column connection device comprising:
a housing comprising first and second opposite ends, the housing comprising a housing bore extending therethrough between the first and second ends of the housing, the housing bore defining a longitudinal axis;
a piston in the housing bore, the piston comprising first and second opposite ends;
a ferrule at least partially in the housing bore at the second end of the piston;
a biasing mechanism in the housing bore at the first end of the piston, the biasing mechanism comprising a conical spring washer;
a retaining member at the first end of the housing and configured to retain the biasing mechanism such that the biasing mechanism urges the piston axially toward the second end of the housing; and
a plurality of fasteners each extending parallel to the longitudinal axis through the retaining member and into the housing, wherein the fasteners do not engage the conical spring washer.
